(19) United States
(12) Patent Application Publication
(10) Pub. No.: US 2026/0181414 A1
(43) Pub. Date: Jun. 25, 2026

(54) SYSTEMS AND METHODS ASSOCIATED WITH AUTONOMOUS SDU RETRANSMISSIONS

(71) Applicant: InterDigital Patent Holdings, Inc., Wilmington, DE (US)

(72) Inventors: Samuli Turtinen, Espoo (FI); Faris Alfarhan, Montreal (CA); Tuong Duc Hoang, Montreal (CA)

(73) Assignee: InterDigital Patent Holdings, Inc., Wilmington, DE (US)

(21) Appl. No.: 18/987,402

(22) Filed: Dec. 19, 2024

(51) Int. Cl. H04W 24/02; H04L 1/1607; H04L 1/1812

(52) U.S. Cl. CPC H04W 24/02; H04L 1/1685; H04L 1/1812

(57) ABSTRACT

Disclosed herein are systems, methods, and instrumentalities associated with autonomous service data unit (SDU) retransmissions and/or radio link failure (RLF) handling. A wireless transmit/receive unit (WTRU) may receive configuration information associated with a service data unit (SDU), wherein the configuration information may indicate a first condition and a second condition associated with SDU retransmission. The first condition may be related at least to a remaining time associated with the SDU and the second condition may be related at least to whether a part of the SDU is pending for transmission. The WTRU may be further configured to determine whether the first condition and the second condition are both met, and based on a determination that the first condition and the second condition are both met, the WTRU may re-transmit at least a segment of the SDU.

### BACKGROUND

Transmissions in a wireless communication system may experience delays or even failures. As such, systems, methods and/or instrumentalities for handling the delays or failures may be desirable to improve the performance and efficiency of the wireless communication system.

### SUMMARY

Disclosed herein are systems, methods and instrumentalities associated with autonomous service data unit (SDU) retransmissions and/or radio link failure (RLF) handling. According to embodiments of the disclosure, a wireless transmit/receive unit (WTRU) may be configured to receive configuration information from a network device (e.g., a base station), wherein the configuration information may be associated with a service data unit (SDU) and may indicate a first condition and a second condition associated with SDU retransmission. The first condition may be related at least to a remaining time associated with the SDU and the second condition may be related at least to whether a part of the SDU is pending for transmission or retransmission. The WTRU may be further configured to determine whether the first condition and the second condition are both met, and based on a determination that the first condition and the second condition are both met, the WTRU may re-transmit at least a segment of the SDU to the network device.

In examples, the WTUR may be configured to re-transmit at least the segment of the SDU autonomously (e.g., without receiving a negative acknowledge (NACK) from the network device). In examples, the WTRU may be configured to determine that the second condition is not met if the part of the SDU is pending for transmission or retransmission. In examples, the second condition may be related further to whether a transmission delay time period associated with a previous transmission or retransmission of the SDU has expired. In these examples, the WTRU may start monitoring the transmission delay time period upon initiating the transmission or retransmission of the SDU and, within the transmission delay time period (e.g., before the time period expires), the WTRU may determine that the second condition is not met.

In examples, the second condition may be related further to whether a transmission delay time period associated with a transmission of a polling request to a network device has expired. The WTRU may start monitoring the transmission delay time period upon transmitting the polling request to the network device and, within the transmission delay time period, the WTRU may determine that the second condition is not met.

In examples, the WTRU may postpone or delay the retransmission of at least the segment of the SDU in response to determining that the first condition is met but the second condition is not met.

In examples, the configuration information received by the WTRU may further indicate a third condition and a fourth condition associated with a transmission of a polling request to the network device for status reporting. The third condition may be related to an amount of data transmitted without polling or a buffer status of the WTRU, while the fourth condition may be related at least to whether the part of the SDU is pending for transmission or whether a transmission delay time period associated with the SDU or with a previously transmitted polling request has expired. In these examples, the WTRU may be further configured to determine whether the third condition and the fourth condition are both met, and transmit the polling request based on a determination that the third condition and the fourth condition are both met.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flow diagram illustrating an example procedure for performing an autonomous retransmission of a SDU or a SDU segment.

FIG. 3 is a flow diagram illustrating an example procedure for performing a conditional transmission of a polling request.

### DETAILED DESCRIPTION

A more detailed understanding can be had from the following description, given by way of example in conjunction with the accompanying drawings.

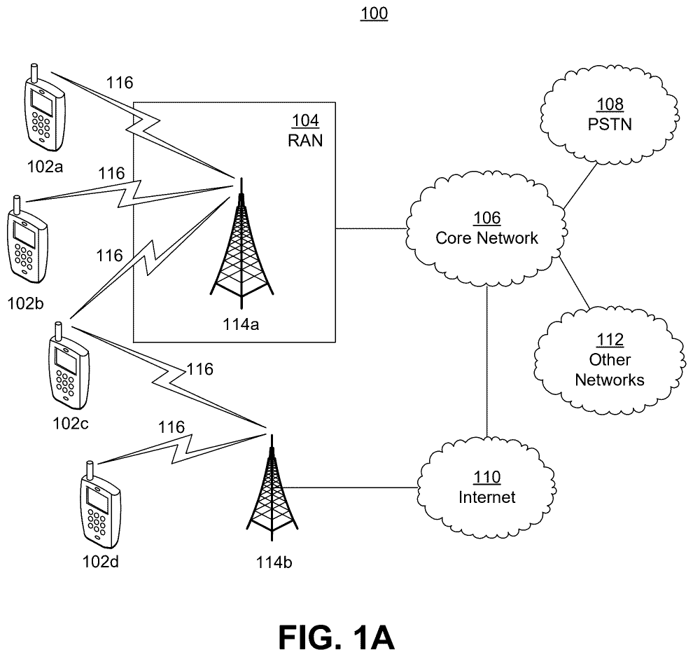

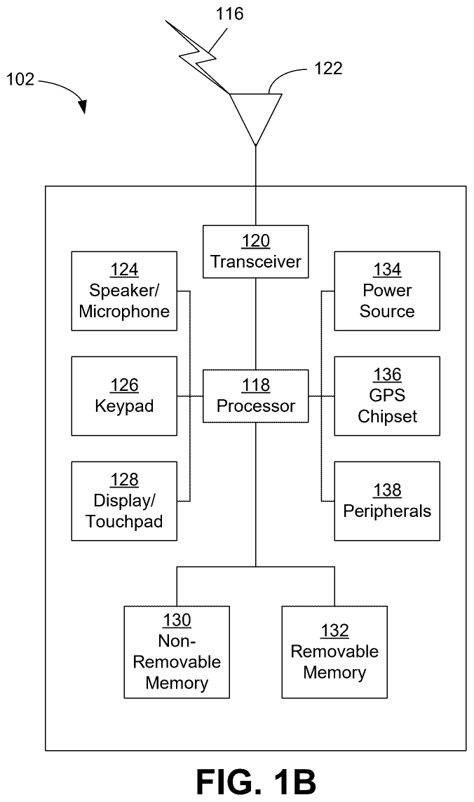

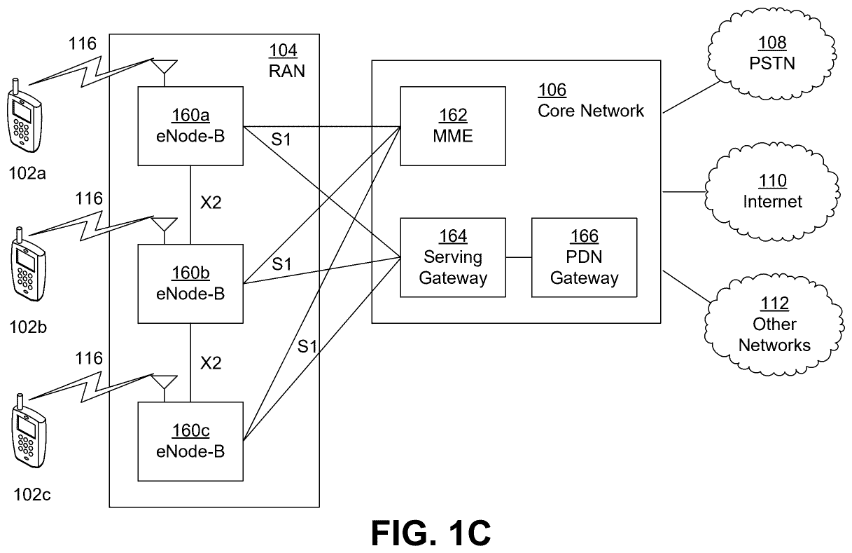

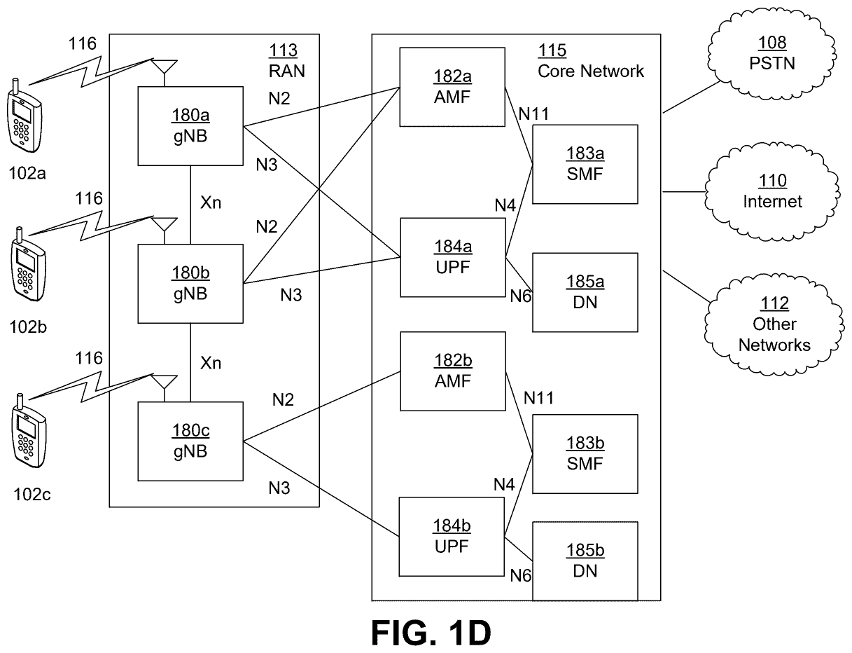

FIG. 1A is a diagram illustrating an example communications system 100 in which one or more disclosed embodiments can be implemented. The communications system 100 can be a multiple access system that provides content, such as voice, data, video, messaging, broadcast, etc., to multiple wireless users. The communications system 100 can enable multiple wireless users to access such content through the sharing of system resources, including wireless bandwidth. For example, the communications systems 100 can employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 can include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d can be any type of device configured to operate and/or communicate in a wireless environment. By way of example, the WTRUs 102a, 102b, 102c, 102d, any of which can be referred to as a “station” and/or a “STA”, can be configured to transmit and/or receive wireless signals and can include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d can be interchangeably referred to as a WTRU.

The communications systems 100 can include a base station 114a and/or a base station 114b. Each of the base stations 114a, 114b can be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b can be a base transceiver station (BTS), a Node-B, an eNode B, a Home Node B, a Home eNode B, a base station, a NR NodeB, a site controller, an access point (AP), a wireless router, and the like. While the base stations 114a, 114b are each depicted as a single element, it will be appreciated that the base stations 114a, 114b can include any number of interconnected base stations and/or network elements.

The base station 114a can be part of the RAN 104/113, which can also include other base stations and/or network elements (not shown), such as a base station controller (BSC), a radio network controller (RNC), relay nodes, etc. The base station 114a and/or the base station 114b can be configured to transmit and/or receive wireless signals on one or more carrier frequencies, which can be referred to as a cell (not shown). These frequencies can be in licensed spectrum, unlicensed spectrum, or a combination of licensed and unlicensed spectrum. A cell can provide coverage for a wireless service to a specific geographical area that can be relatively fixed or that can change over time. The cell can further be divided into cell sectors. For example, the cell associated with the base station 114a can be divided into three sectors. Thus, in one embodiment, the base station 114a can include three transceivers, i.e., one for each sector of the cell. In an embodiment, the base station 114a can employ multiple-input multiple output (MIMO) technology and can utilize multiple transceivers for each sector of the cell. For example, beamforming can be used to transmit and/or receive signals in desired spatial directions.

The base stations 114a, 114b can communicate with one or more of the WTRUs 102a, 102b, 102c, 102d over an air interface 116, which can be any suitable wireless communication link (e.g., radio frequency (RF), microwave, centimeter wave, micrometer wave, infrared (IR), ultraviolet (UV), visible light, etc.). The air interface 116 can be established using any suitable radio access technology (RAT).

More specifically, as noted above, the communications system 100 can be a multiple access system and can employ one or more channel access schemes, such as CDMA, TDMA, FDMA, OFDMA, SC-FDMA, and the like. For example, the base station 114a in the RAN 104/113 and the WTRUs 102a, 102b, 102c can implement a radio technology such as Universal Mobile Telecommunications System (UMTS) Terrestrial Radio Access (UTRA), which can establish the air interface 115/116/117 using wideband CDMA (WCDMA). WCDMA can include communication protocols such as High-Speed Packet Access (HSPA) and/or Evolved HSPA (HSPA+). HSPA can include High-Speed Downlink (DL) Packet Access (HSDPA) and/or High-Speed UL Packet Access (HSUPA).

In an embodiment, the base station 114a and the WTRUs 102a, 102b, 102c can implement a radio technology such as Evolved UMTS Terrestrial Radio Access (E-UTRA), which can establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c can implement a radio technology such as NR Radio Access, which can establish the air interface 116 using New Radio (NR).

In an embodiment, the base station 114a and the WTRUs 102a, 102b, 102c can implement multiple radio access technologies. For example, the base station 114a and the WTRUs 102a, 102b, 102c can implement LTE radio access and NR radio access together, for instance using dual connectivity (DC) principles. Thus, the air interface utilized by WTRUs 102a, 102b, 102c can be characterized by multiple types of radio access technologies and/or transmissions sent to/from multiple types of base stations (e.g., a eNB and a base station).

In other embodiments, the base station 114a and the WTRUs 102a, 102b, 102c can implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A can be a wireless router, Home Node B, Home eNode B, or access point, for example, and can utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d can implement a radio technology such as IEEE 802.11 to establish a wireless local area network (WLAN). In an embodiment, the base station 114b and the WTRUs 102c, 102d can implement a radio technology such as IEEE 802.15 to establish a wireless personal area network (WPAN). In yet another embodiment, the base station 114b and the WTRUs 102c, 102d can utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b can have a direct connection to the Internet 110. Thus, the base station 114b can not be required to access the Internet 110 via the CN 106/115.

The RAN 104/113 can be in communication with the CN 106/115, which can be any type of network configured to provide voice, data, applications, and/or voice over internet protocol (VolP) services to one or more of the WTRUs 102a, 102b, 102c, 102d. The data can have varying quality of service (QOS) requirements, such as differing throughput requirements, latency requirements, error tolerance requirements, reliability requirements, data throughput requirements, mobility requirements, and the like. The CN 106/115 can provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 can be in direct or indirect communication with other RANs that employ the same RAT as the RAN 104/113 or a different RAT. For example, in addition to being connected to the RAN 104/113, which can be utilizing a NR radio technology, the CN 106/115 can also be in communication with another RAN (not shown) employing a GSM, UMTS, CDMA 2000, WiMAX, E-UTRA, or WiFi radio technology.

The CN 106/115 can also serve as a gateway for the WTRUs 102a, 102b, 102c, 102d to access the PSTN 108, the Internet 110, and/or the other networks 112. The PSTN 108 can include circuit-switched telephone networks that provide plain old telephone service (POTS). The Internet 110 can include a global system of interconnected computer networks and devices that use common communication protocols, such as the transmission control protocol (TCP), user datagram protocol (UDP) and/or the internet protocol (IP) in the TCP/IP internet protocol suite. The networks 112 can include wired and/or wireless communications networks owned and/or operated by other service providers. For example, the networks 112 can include another CN connected to one or more RANs, which can employ the same RAT as the RAN 104/113 or a different RAT.

One or more (e.g., all) of the WTRUs 102a, 102b, 102c, 102d in the communications system 100 can include multi-mode capabilities (e.g., the WTRUs 102a, 102b, 102c, 102d can include multiple transceivers for communicating with different wireless networks over different wireless links). For example, the WTRU 102c shown in FIG. 1A can be configured to communicate with the base station 114a, which can employ a cellular-based radio technology, and with the base station 114b, which can employ an IEEE 802 radio technology.

FIG. 1B is a system diagram illustrating an example WTRU 102. As shown in FIG. 1B, the WTRU 102 can include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 can include any sub-combination of the foregoing elements while remaining consistent with an embodiment.

The processor 118 can be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 can perform signal coding, data processing, power control, input/output processing, and/or any other functionality that enables the WTRU 102 to operate in a wireless environment. The processor 118 can be coupled to the transceiver 120, which can be coupled to the transmit/receive element 122. While FIG. 1B depicts the processor 118 and the transceiver 120 as separate components, it will be appreciated that the processor 118 and the transceiver 120 can be integrated together in an electronic package or chip.

The transmit/receive element 122 can be configured to transmit signals to, or receive signals from, a base station (e.g., the base station 114a) over the air interface 116. For example, in one embodiment, the transmit/receive element 122 can be an antenna configured to transmit and/or receive RF signals. In an embodiment, the transmit/receive element 122 can be an emitter/detector configured to transmit and/or receive IR, UV, or visible light signals, for example. In yet another embodiment, the transmit/receive element 122 can be configured to transmit and/or receive both RF and light signals. It will be appreciated that the transmit/receive element 122 can be configured to transmit and/or receive any combination of wireless signals.

Although the transmit/receive element 122 is depicted in FIG. 1B as a single element, the WTRU 102 can include any number of transmit/receive elements 122. More specifically, the WTRU 102 can employ MIMO technology. Thus, in one embodiment, the WTRU 102 can include two or more transmit/receive elements 122 (e.g., multiple antennas) for transmitting and receiving wireless signals over the air interface 116.

The transceiver 120 can be configured to modulate the signals that are to be transmitted by the transmit/receive element 122 and to demodulate the signals that are received by the transmit/receive element 122. As noted above, the WTRU 102 can have multi-mode capabilities. Thus, the transceiver 120 can include multiple transceivers for enabling the WTRU 102 to communicate via multiple RATs, such as NR and IEEE 802.11, for example.

The processor 118 of the WTRU 102 can be coupled to, and can receive user input data from, the speaker/microphone 124, the keypad 126, and/or the display/touchpad 128 (e.g., a liquid crystal display (LCD) display unit or organic light-emitting diode (OLED) display unit). The processor 118 can also output user data to the speaker/microphone 124, the keypad 126, and/or the display/touchpad 128. In addition, the processor 118 can access information from, and store data in, any type of suitable memory, such as the non-removable memory 130 and/or the removable memory 132. The non-removable memory 130 can include random-access memory (RAM), read-only memory (ROM), a hard disk, or any other type of memory storage device. The removable memory 132 can include a subscriber identity module (SIM) card, a memory stick, a secure digital (SD) memory card, and the like. In other embodiments, the processor 118 can access information from, and store data in, memory that is not physically located on the WTRU 102, such as on a server or a home computer (not shown).

The processor 118 can receive power from the power source 134, and can be configured to distribute and/or control the power to the other components in the WTRU 102. The power source 134 can be any suitable device for powering the WTRU 102. For example, the power source 134 can include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 can also be coupled to the GPS chipset 136, which can be configured to provide location information (e.g., longitude and latitude) regarding the current location of the WTRU 102. In addition to, or in lieu of, the information from the GPS chipset 136, the WTRU 102 can receive location information over the air interface 116 from a base station (e.g., base stations 114a, 114b) and/or determine its location based on the timing of the signals being received from two or more nearby base stations. It will be appreciated that the WTRU 102 can acquire location information by way of any suitable location-determination method while remaining consistent with an embodiment.

The processor 118 can further be coupled to other peripherals 138, which can include one or more software and/or hardware modules that provide additional features, functionality and/or wired or wireless connectivity. For example, the peripherals 138 can include an accelerometer, an e-compass, a satellite transceiver, a digital camera (for photographs and/or video), a universal serial bus (USB) port, a vibration device, a television transceiver, a hands free headset, a Bluetooth@ module, a frequency modulated (FM) radio unit, a digital music player, a media player, a video game player module, an Internet browser, a Virtual Reality and/or Augmented Reality (VR/AR) device, an activity tracker, and the like. The peripherals 138 can include one or more sensors, the sensors can be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 can include a full duplex radio for which transmission and reception of some or all of the signals (e.g., associated with particular subframes for both the UL (e.g., for transmission) and downlink (e.g., for reception) can be concurrent and/or simultaneous. The full duplex radio can include an interference management unit to reduce and or substantially eliminate self-interference via either hardware (e.g., a choke) or signal processing via a processor (e.g., a separate processor (not shown) or via processor 118). In an embodiment, the WTRU 102 can include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 can employ an E-UTRA radio technology to communicate with the WTRUs 102a, 102b, 102c over the air interface 116. The RAN 104 can also be in communication with the CN 106.

The RAN 104 can include eNode-Bs 160a, 160b, 160c, though it will be appreciated that the RAN 104 can include any number of eNode-Bs while remaining includeent with an embodiment. The eNode-Bs 160a, 160b, 160c can each include one or more transceivers for communicating with the WTRUs 102a, 102b, 102c over the air interface 116. In one embodiment, the eNode-Bs 160a, 160b, 160c can implement MIMO technology. Thus, the eNode-B 160a, for example, can use multiple antennas to transmit wireless signals to, and/or receive wireless signals from, the WTRU 102a.

Each of the eNode-Bs 160a, 160b, 160c can be associated with a particular cell (not shown) and can be configured to handle radio resource management decisions, handover decisions, scheduling of users in the UL and/or DL, and the like. As shown in FIG. 1C, the eNode-Bs 160a, 160b, 160c can communicate with one another over an X2 interface.

The CN 106 shown in FIG. 1C can include a mobility management entity (MME) 162, a serving gateway (SGW) 164, and a packet data network (PDN) gateway (or PGW) 166. While each of the foregoing elements are depicted as part of the CN 106, it will be appreciated that any of these elements can be owned and/or operated by an entity other than the CN operator.

The MME 162 can be connected to each of the eNode-Bs 160a, 160b, 160c in the RAN 104 via an S1 interface and can serve as a control node. For example, the MME 162 can be responsible for authenticating users of the WTRUs 102a, 102b, 102c, bearer activation/deactivation, selecting a particular serving gateway during an initial attach of the WTRUs 102a, 102b, 102c, and the like. The MME 162 can provide a control plane function for switching between the RAN 104 and other RANs (not shown) that employ other radio technologies, such as GSM and/or WCDMA.

The SGW 164 can be connected to each of the eNode Bs 160a, 160b, 160c in the RAN 104 via the S1 interface. The SGW 164 can generally route and forward user data packets to/from the WTRUs 102a, 102b, 102c. The SGW 164 can perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 can be connected to the PGW 166, which can provide the WTRUs 102a, 102b, 102c with access to packet-switched networks, such as the Internet 110, to facilitate communications between the WTRUs 102a, 102b, 102c and IP-enabled devices.

The CN 106 can facilitate communications with other networks. For example, the CN 106 can provide the WTRUs 102a, 102b, 102c with access to circuit-switched networks, such as the PSTN 108, to facilitate communications between the WTRUs 102a, 102b, 102c and traditional land-line communications devices. For example, the CN 106 can include, or can communicate with, an IP gateway (e.g., an IP multimedia subsystem (IMS) server) that serves as an interface between the CN 106 and the PSTN 108. In addition, the CN 106 can provide the WTRUs 102a, 102b, 102c with access to the other networks 112, which can include other wired and/or wireless networks that are owned and/or operated by other service providers.

Although the WTRU is described in FIGS. 1A-1D as a wireless terminal, it is contemplated that in certain representative embodiments that such a terminal can use (e.g., temporarily or permanently) wired communication interfaces with the communication network.

In representative embodiments, the other network 112 can be a WLAN.

A WLAN in Infrastructure Basic Service Set (BSS) mode can have an Access Point (AP) for the BSS and one or more stations (STAs) associated with the AP. The AP can have an access or an interface to a Distribution System (DS) or another type of wired/wireless network that carries traffic in to and/or out of the BSS. Traffic to STAs that originates from outside the BSS can arrive through the AP and can be delivered to the STAs. Traffic originating from STAs to destinations outside the BSS can be sent to the AP to be delivered to respective destinations. Traffic between STAs within the BSS can be sent through the AP, for example, where the source STA can send traffic to the AP and the AP can deliver the traffic to the destination STA. The traffic between STAs within a BSS can be considered and/or referred to as peer-to-peer traffic. The peer-to-peer traffic can be sent between (e.g., directly between) the source and destination STAs with a direct link setup (DLS). In certain representative embodiments, the DLS can use an 802.11e DLS or an 802.11z tunneled DLS (TDLS). A WLAN using an Independent BSS (IBSS) mode cannot have an AP, and the STAs (e.g., all of the STAs) within or using the IBSS can communicate directly with each other. The IBSS mode of communication can sometimes be referred to herein as an “ad-hoc” mode of communication.

When using the 802.11ac infrastructure mode of operation or a similar mode of operations, the AP can transmit a beacon on a fixed channel, such as a primary channel. The primary channel can be a fixed width (e.g., 20 MHz wide bandwidth) or a dynamically set width via signaling. The primary channel can be the operating channel of the BSS and can be used by the STAs to establish a connection with the AP. In certain representative embodiments, Carrier Sense Multiple Access with Collision Avoidance (CSMA/CA) can be implemented, for example in in 802.11 systems. For CSMA/CA, the STAs (e.g., every STA), including the AP, can sense the primary channel. If the primary channel is sensed/detected and/or determined to be busy by a particular STA, the particular STA can back off. One STA (e.g., only one station) can transmit at any given time in a given BSS.

High Throughput (HT) STAs can use a 40 MHz wide channel for communication, for example, via a combination of the primary 20 MHz channel with an adjacent or nonadjacent 20 MHz channel to form a 40 MHz wide channel.

Very High Throughput (VHT) STAs can support 20 MHz, 40 MHz, 80 MHz, and/or 160 MHz wide channels. The 40 MHz, and/or 80 MHz, channels can be formed by combining contiguous 20 MHz channels. A 160 MHz channel can be formed by combining 8 contiguous 20 MHz channels, or by combining two non-contiguous 80 MHz channels, which can be referred to as an 80+80 configuration. For the 80+80 configuration, the data, after channel encoding, can be passed through a segment parser that can divide the data into two streams. Inverse Fast Fourier Transform (IFFT) processing, and time domain processing, can be done on each stream separately. The streams can be mapped on to the two 80 MHz channels, and the data can be transmitted by a transmitting STA. At the receiver of the receiving STA, the above described operation for the 80+80 configuration can be reversed, and the combined data can be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah can support Meter Type Control/Machine-Type Communications, such as MTC devices in a macro coverage area. MTC devices can have certain capabilities, for example, limited capabilities including support for (e.g., only support for) certain and/or limited bandwidths. The MTC devices can include a battery with a battery life above a threshold (e.g., to maintain a very long battery life).

WLAN systems, which can support multiple channels, and channel bandwidths, such as 802.11n, 802.11ac, 802.11af, and 802.11ah, include a channel which can be designated as the primary channel. The primary channel can have a bandwidth equal to the largest common operating bandwidth supported by all STAs in the BSS. The bandwidth of the primary channel can be set and/or limited by a STA, from among all STAs in operating in a BSS, which supports the smallest bandwidth operating mode. In the example of 802.11ah, the primary channel can be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings can depend on the status of the primary channel. If the primary channel is busy, for example, due to a STA (which supports only a 1 MHz operating mode), transmitting to the AP, the entire available frequency bands can be considered busy even though a majority of the frequency bands remains idle and can be available.

In the United States, the available frequency bands, which can be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 can employ an NR radio technology to communicate with the WTRUs 102a, 102b, 102c over the air interface 116. The RAN 113 can also be in communication with the CN 115.

The RAN 113 can include base stations 180a, 180b, 180c, though it will be appreciated that the RAN 113 can include any number of base stations while remaining consistent with an embodiment. The base stations 180a, 180b, 180c can each include one or more transceivers for communicating with the WTRUS 102a, 102b, 102c over the air interface 116. In one embodiment, the base stations 180a, 180b, 180c can implement MIMO technology. For example, base stations 180a, 108b can utilize beamforming to transmit signals to and/or receive signals from the base stations 180a, 180b, 180c. Thus, the base station 180a, for example, can use multiple antennas to transmit wireless signals to, and/or receive wireless signals from, the WTRU 102a. In an embodiment, the base stations 180a, 180b, 180c can implement carrier aggregation technology. For example, the base station 180a can transmit multiple component carriers to the WTRU 102a (not shown). A subset of these component carriers can be on unlicensed spectrum while the remaining component carriers can be on licensed spectrum. In an embodiment, the base stations 180a, 180b, 180c can implement Coordinated Multi-Point (COMP) technology. For example, WTRU 102a can receive coordinated transmissions from base station 180a and base station 180b (and/or base station 180c).

The WTRUs 102a, 102b, 102c can communicate with base stations 180a, 180b, 180c using transmissions associated with a scalable numerology. For example, the OFDM symbol spacing and/or OFDM subcarrier spacing can vary for different transmissions, different cells, and/or different portions of the wireless transmission spectrum. The WTRUs 102a, 102b, 102c can communicate with base stations 180a, 180b, 180c using subframe or transmission time intervals (TTls) of various or scalable lengths (e.g., containing varying number of OFDM symbols and/or lasting varying lengths of absolute time).

The base stations 180a, 180b, 180c can be configured to communicate with the WTRUs 102a, 102b, 102c in a standalone configuration and/or a non-standalone configuration. In the standalone configuration, WTRUs 102a, 102b, 102c can communicate with base stations 180a, 180b, 180c without also accessing other RANs (e.g., such as eNode-Bs 160a, 160b, 160c). In the standalone configuration, WTRUs 102a, 102b, 102c can utilize one or more of base stations 180a, 180b, 180c as a mobility anchor point. In the standalone configuration, WTRUs 102a, 102b, 102c can communicate with base stations 180a, 180b, 180c using signals in an unlicensed band. In a non-standalone configuration WTRUs 102a, 102b, 102c can communicate with/connect to base stations 180a, 180b, 180c while also communicating with/connecting to another RAN such as eNode-Bs 160a, 160b, 160c. For example, WTRUs 102a, 102b, 102c can implement DC principles to communicate with one or more base stations 180a, 180b, 180c and one or more eNode-Bs 160a, 160b, 160c substantially simultaneously. In the non-standalone configuration, eNode-Bs 160a, 160b, 160c can serve as a mobility anchor for WTRUs 102a, 102b, 102c and base stations 180a, 180b, 180c can provide additional coverage and/or throughput for servicing WTRUs 102a, 102b, 102c.

Each of the base stations 180a, 180b, 180c can be associated with a particular cell (not shown) and can be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the base stations 180a, 180b, 180c can communicate with one another over an Xn interface.

The CN 115 shown in FIG. 1D can include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements can be owned and/or operated by an entity other than the CN operator.

The AMF 182a, 182b can be connected to one or more of the base stations 180a, 180b, 180c in the RAN 113 via an N2 interface and can serve as a control node. For example, the AMF 182a, 182b can be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing can be used by the AMF 182a, 182b in order to customize CN support for WTRUs 102a, 102b, 102c based on the types of services being utilized WTRUs 102a, 102b, 102c. For example, different network slices can be established for different use cases such as services relying on ultra-reliable low latency (URLLC) access, services relying on enhanced massive mobile broadband (eMBB) access, services for machine type communication (MTC) access, and/or the like. The AMF 162 can provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b can be connected to an AMF 182a, 182b in the CN 115 via an N11 interface. The SMF 183a, 183b can also be connected to a UPF 184a, 184b in the CN 115 via an N4 interface. The SMF 183a, 183b can select and control the UPF 184a, 184b and configure the routing of traffic through the UPF 184a, 184b. The SMF 183a, 183b can perform other functions, such as managing and allocating WTRU IP address, managing PDU sessions, controlling policy enforcement and QoS, providing downlink data notifications, and the like. A PDU session type can be IP-based, non-IP based, Ethernet-based, and the like.

The UPF 184a, 184b can be connected to one or more of the base stations 180a, 180b, 180c in the RAN 113 via an N3 interface, which can provide the WTRUs 102a, 102b, 102c with access to packet-switched networks, such as the Internet 110, to facilitate communications between the WTRUs 102a, 102b, 102c and IP-enabled devices. The UPF 184, 184b can perform other functions, such as routing and forwarding packets, enforcing user plane policies, supporting multi-homed PDU sessions, handling user plane QoS, buffering downlink packets, providing mobility anchoring, and the like.

The CN 115 can facilitate communications with other networks. For example, the CN 115 can include, or can communicate with, an IP gateway (e.g., an IP multimedia subsystem (IMS) server) that serves as an interface between the CN 115 and the PSTN 108. In addition, the CN 115 can provide the WTRUs 102a, 102b, 102c with access to the other networks 112, which can include other wired and/or wireless networks that are owned and/or operated by other service providers. In one embodiment, the WTRUs 102a, 102b, 102c can be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, base station 180a-c, AMF 182a-b, UPF 184a-b, SMF 183a-b, DN 185a-b, and/or any other device(s) described herein, can be performed by one or more emulation devices (not shown). The emulation devices can be one or more devices configured to emulate one or more, or all, of the functions described herein. For example, the emulation devices can be used to test other devices and/or to simulate network and/or WTRU functions.

The emulation devices can be designed to implement one or more tests of other devices in a lab environment and/or in an operator network environment. For example, the one or more emulation devices can perform the one or more, or all, functions while being fully or partially implemented and/or deployed as part of a wired and/or wireless communication network in order to test other devices within the communication network. The one or more emulation devices can perform the one or more, or all, functions while being temporarily implemented/deployed as part of a wired and/or wireless communication network. The emulation device can be directly coupled to another device for purposes of testing and/or can perform testing using over-the-air wireless communications.

The one or more emulation devices can perform the one or more, including all, functions while not being implemented/deployed as part of a wired and/or wireless communication network. For example, the emulation devices can be utilized in a testing scenario in a testing laboratory and/or a non-deployed (e.g., testing) wired and/or wireless communication network in order to implement testing of one or more components. The one or more emulation devices can be test equipment. Direct RF coupling and/or wireless communications via RF circuitry (e.g., which can include one or more antennas) can be used by the emulation devices to transmit and/or receive data.

Data (e.g., one or more service data units (SDUs) or one or more segments of a SDU) may be retransmitted. For example, the transmitting side of an acknowledge mode (AM) radio link control (RLC) entity may receive a negative acknowledgement (e.g., a notification of reception failure by a peer AM RLC entity) for an RLC SDU or an RLC SDU segment (e.g., the negative acknowledge may be received via a STATUS PDU from the peer AM RLC entity). In response, the transmitting side of the AM RLC entity may consider the RLC SDU or the RLC SDU segment for which the negative acknowledgement was received for retransmission. The transmitting side of the AM RLC entity may do so, for example, if the sequence number (SN) of the corresponding RLC SDU falls within the range TX_Next_Ack<=SN<=the highest SN of the AMD PDU among the AMD PDUs submitted to a lower layer. If the RLC SDU or an RLC SDU segment is considered for retransmission, the transmitting side of the AM RLC entity may set the RETX_COUNT associated with the RLC SDU to zero if the RLC SDU or RLC SDU segment is considered for retransmission for the first time. The transmitting side of the AM RLC entity may increment the RETX_COUNT if the RLC SDU or the RLC SDU segment that is considered for retransmission is not pending for retransmission already and the RETX_COUNT associated with the RLC SDU has not been incremented due to another negative acknowledgment in the same STATUS PDU. If RETX_COUNT reaches a maximum retransmission threshold (e.g., if RETX_COUNT=maxRetxThreshold), the transmitting side of the AM RLC entity indicate to upper layers that max retransmission has been reached.

When retransmitting the RLC SDU or the RLC SDU segment, the transmitting side of the AM RLC entity may segment the RLC SDU or the RLC SDU segment, form a new AMD PDU that may fit within the total size of AMD PDU(s) indicated by a lower layer at a particular transmission opportunity, and/or submit the new AMD PDU to the lower layer. When forming the new AMD PDU, the transmitting side of the AM RLC entity may map the original RLC SDU or RLC SDU segment to the Data field of the new AMD PDU, modify the header of the new AMD PDU, and/or set a field (e.g., the P field) of the new AMD PDU to indicate whether or not the transmitting side of the AM RLC entity requests a STATUS report from the peer AM RLC entity (e.g., the field may be set to ‘0’ to indicate that status reporting is not requested, and set to ‘1’ to indicate that status reporting is requested).

If the AM RLC entity indicates to upper layers that max retransmission has been reached for the RLC SDU, different actions may be triggered depending on which cell group the AM RLC entity belongs to. For example, if the AM RLC entity belongs to a MCG (master cell group), a radio link failure (RLF) procedure may be triggered, and if the AM RLC entity belongs to a SCG (secondary cell Group), an SCG failure procedure may be trigged. The AM RLC entity may consider the SDU (or a segment of the SDU) for re-transmission if (e.g., only if) a STATUS PDU is received from the peer RLC entity indicating the re-transmission. The network may use this mechanism to regulate the number of retransmissions and the duration between retransmissions, in the case of UL data transmissions.

Autonomous SDU retransmissions (e.g., without or prior to receiving a STATUS PDU comprising or indicating a negative acknowledgment associated with the SDU) may be performed. Such autonomous retransmissions (auto re-tx) may include a case where a WTRU (e.g., an RLC entity associated with the WTRU) may trigger a retransmission of an RLC SDU or an RLC SDU segment without receiving a STATUS PDU indicative of the retransmission. The autonomous retransmissions may be triggered by or based on various conditions including, for example, a remaining time associated with the RLC SDU (e.g., a remaining time for completing the transmission of the SDU) falling below a threshold (e.g., based on a discardTimer associated with the remaining time), or a number of HARQ retransmissions associated with the SDU having been performed without success.

An AM RLC entity may poll its peer AM RLC entity (e.g., in order to trigger STATUS reporting at the peer AM RLC entity). The polling may be performed based on one or more triggers or conditions. For examples, upon notification of a transmission opportunity by a lower layer, for an acknowledged mode data (AMD) PDU (e.g., for each AMD PDU) submitted for transmission (e.g., such that the AMD PDU may include an RLC SDU or an RLC SDU segment not previously transmitted), the transmitting side of the AM RLC entity may increment PDU_WITHOUT_POLL by one and/or increment BYTE_WITHOUT_POLL by every new byte of Data field element that is mapped to the Data field of the AMD PDU. If PDU_WITHOUT_POLL>=pollPDU or if BYTE_WITHOUT_POLL>=pollByte, the transmitting side of the AM RLC entity may include a poll in the AMD PDU. As another example, upon notification of a transmission opportunity by a lower layer, for an (e.g., each) AMD PDU submitted for transmission, the transmitting side of an AM RLC entity may include a poll in the AMD PDU if a transmission buffer and/or a retransmission buffer becomes empty (e.g., excluding transmitted RLC SDUs or RLC SDU segments awaiting acknowledgements) after the transmission of the AMD PDU, or if no new RLC SDU can be transmitted after the transmission of the AMD PDU (e.g., due to window stalling). The empty RLC buffer (e.g., excluding transmitted RLC SDUs or RLC SDU segments awaiting acknowledgements) should not lead to unnecessary polling when data awaits in an upper layer.

A poll (e.g., a polling request) may be transmitted (e.g., included in an AMD PDU) based on additional triggers or conditions including, for example, whether a PDU set (e.g., which include multiple PDUs) has been fully transmitted, whether a remaining time associated with an SDU has fallen below a threshold (e.g., based on a discardTimer associated with the remaining time), etc.

An autonomous re-transmission of an SDU or an SDU segment and/or the transmission of a polling request may be based on triggers or conditions other than (e.g., in addition to) the remaining time threshold described herein or an HARQ retransmission count (e.g., if an SDU has just been transmitted, retransmissions of the SDU or a polling request transmission may not be necessary). These other/additional triggers or conditions may allow a WTRU or a network device to control how frequently and/or how fast autonomous SDU retransmissions and/or polling request transmissions are performed. The autonomous re-transmissions of SDUs may, in some situations (e.g., when a scheme based on a maxRetxThreshold is used), lead to a faster (e.g., immediate) RLF, which may be problematic since a network device may not know the remaining time associated with an SDU. Therefore, the network device and/or a WTRU may adopt techniques to avoid unnecessary RLF triggers that may be caused by autonomous SDU re-transmissions.

With respect to an autonomous retransmission of a SDU or a SDU segment, a WTRU may be configured with a first set of one or more conditions and a second set of one or more conditions under which the autonomous SDU re-transmission may be triggered. The WTRU may perform the autonomous SDU retransmission if both the first and second sets of conditions are met (e.g., fulfilled). The WTRU may be configured to perform the autonomous SDU retransmission via a configured entity (e.g., an RLC entity). In examples, the first set of condition(s) may be related to whether a remaining time associated with a SDU has fallen below a threshold and/or whether a maximum number of HARQ retransmissions associated with the SDU has been performed. In examples, the second set of condition(s) may be related to whether a part of the SDU is pending for transmission (e.g., an initial transmission) or retransmission (e.g., in a transmission or retransmission buffer of the WTRU), whether a transmission delay time period associated with a previous transmission of the SDU has expired (e.g., as indicated by a first timer), and/or whether a transmission delay time period associated with a previous transmission of a polling request has expired (e.g., as indicated by a second timer). In response to determining that the first set of condition(s) and the second set of condition(s) are both met or fulfilled, the WTRU may consider, initiate, or trigger an autonomous re-transmission of the SDU or a segment of the SDU (e.g., via an RLC entity of the WTRU).

With respect to the transmission of a polling request (e.g., a request for status reporting from a peer device or entity), the WTRU may be configured with a third set of one or more conditions and a fourth set of one or more conditions under which the polling request transmission may be triggered. The WTRU may transmit the polling request if both the third and fourth sets of conditions are met (e.g., fulfilled). The WTRU may be configured to transmit the polling request via RLC PDU. In examples, the third set of condition(s) may be related to whether a certain amount of data has been transmitted without polling (e.g., based on a preconfigured threshold) or a buffer status of the WTRU (e.g., whether the buffer is empty). In examples, the fourth set of conditions may be related to whether a part of a SDU is pending for transmission (e.g., an initial transmission) or retransmission (e.g., in a transmission or retransmission buffer of the WTRU), whether a transmission delay time period associated with a previous transmission of a SDU has expired (e.g., as indicated by a first timer), and/or whether a transmission delay time period associated with a previous transmission of a polling request has expired (e.g., as indicated by a second timer). In response to determining that the third set of condition(s) and the fourth set of condition(s) are both met or fulfilled, the WTRU may consider, initiate, or trigger a polling request transmission (e.g., in an RLC PDU).

Using the techniques described herein, autonomous retransmissions of a SDU (or a SDU segment) may not be triggered unless there are benefits associated with the retransmissions (e.g., without acknowledgment from the network), which may lead to savings in system capacity and/or resources.

It should be noted that the sections 3. Focus Solution Summary and 5. Example Solutions have been written in general terms without referring to a particular entity type as under this section. This section is written from NR RLC entity point of view while in 6G some other entity may perform the same actions. Hence, generality should be preserved.

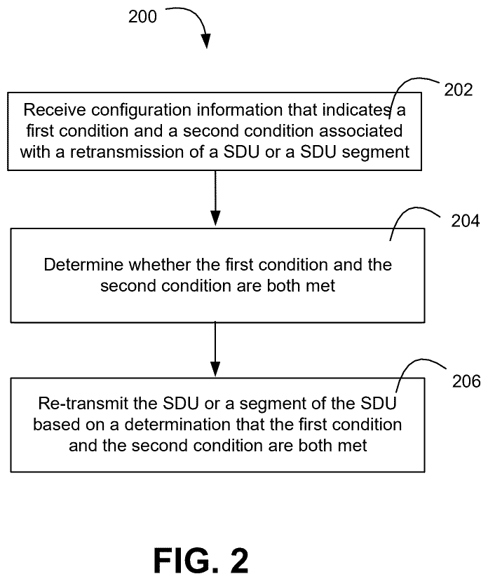

FIG. 2 shows an example procedure 200 for performing an autonomous retransmission of a SDU or a SDU segment. As shown in FIG. 2, the procedure 200 may include receiving, at 202, configuration information, wherein the configuration information may indicate a first condition and a second condition associated with a retransmission of one or more segments of a SDU. In examples, the first condition may be related to whether a negative acknowledgment associated with the SDU has been received, whether a remaining time associated with the SDU has fallen below a threshold, whether a maximum number of retransmissions has been performed for the SDU, etc. In examples, the second condition may be related to whether a part of the SDU is pending for transmission (e.g., an initial transmission or a retransmission), whether a transmission delay time period associated with a transmission of the SDU has expired, and/or whether a transmission delay time period associated with a transmission of a polling request (e.g., to a network device) has expired. At 204, the WTRU may determine whether the first condition and the second condition are both met. Based on a determination that the first condition and the second condition are both met, the WTRU may re-transmit the SDU or a segment of the SDU (e.g., to a network device such as a base station) at 206.

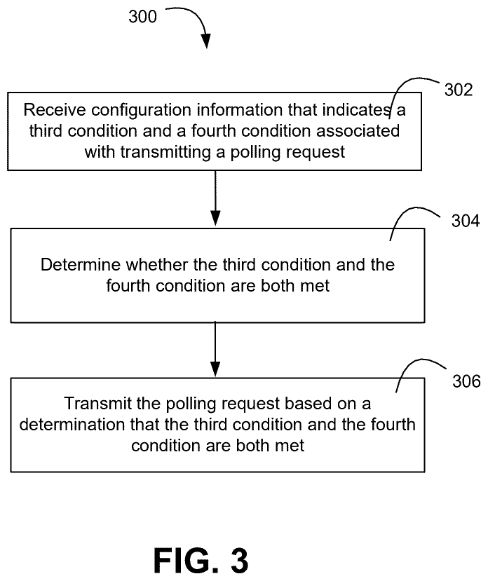

FIG. 3 shows an example procedure 300 for performing a conditional transmission of a polling request. As shown in FIG. 3, the procedure 300 may include receiving, at 302, configuration information, wherein the configuration information may indicate a third condition and a fourth condition associated with transmitting a polling request (e.g., for status reporting). In examples, the third condition may be related to whether a certain amount of data (e.g., based on a threshold) has been transmitted without polling or a buffer status of the WTRU (e.g., whether the buffer is empty). In examples, the fourth condition may be related to whether a part of a SDU is pending for transmission (e.g., an initial transmission or a retransmission), and/or whether a transmission delay time period associated with the SDU or with a previously transmitted polling request has expired. At 304, the WTRU may determine whether the third condition and the fourth condition are both met. Based on a determination that the third and the fourth conditions are both met, the WTRU may transmit a polling request (e.g., in an RLC PDU) at 306.

In examples, the WTRU may be configured to perform the autonomous retransmission or the polling request transmission via a configured RLC entity. The WTRU may be configured with a first remaining time threshold (e.g., a t-ThresholdPoll information element (IE)) associated with polling request transmissions, and the RLC entity may trigger a polling request transmission when the remaining time of an SDU falls below this configured threshold. The WTRU may be configured with a second remaining time threshold (e.g., t-ThresholdAutoReTx) and the RLC entity may trigger an autonomous retransmission of an SDU (or a SDU segment) when the remaining time of the RLC SDU falls below this configured threshold (e.g., the first and second thresholds may be the same or they may be different). The WTRU may be configured with a threshold for a maximum number of HARQ retransmissions for a HARQ process, after which an autonomous re-transmission may be triggered for an SDU (e.g., a segment of the SDU) associated with the HARQ process.

It should be noted that the WTRU may trigger a retransmission for (e.g., only for) a part or a segment of an SDU that has not been acknowledged by a peer RLC entity (e.g., an autonomous retransmission may consist of a full SDU or one or more segments of the SDU). In examples, if an SDU includes data of varying types or varying remaining times, the WTRU may trigger a retransmission for (e.g., only for) parts of the SDU that have their configured conditions for autonomous retransmission met (e.g., having a remaining time such as a discard timer value less than a configured threshold (e.g. t-ThresholdAutoReTx), having retransmission data from a configured set of LCHs, having retransmission data from a configured set of priorities, etc.). The remaining time described herein may be determined or monitored based on a timer such as a discardTimer running at a PDCP layer.

As described herein, a first condition for an autonomous retransmission of a SDU or a transmission of a polling request may be based on a remaining time of an SDU falling below a threshold (e.g., the t-ThresholdPoll or t-ThresholdAutoReTx described herein). Upon determining that such a first condition is met, a WTRU (e.g., an RLC entity of the WTRU) may further evaluate (e.g., as a second condition) whether at least a part of the SDU is still pending for transmission (e.g., an initial transmission or a retransmission) in a buffer of the WTRU. If at least a part of the SDU is pending for transmission or retransmission, the WTRU may delay triggering a retransmission of the SDU (e.g., a segment of the SDU) or the transmission of a poll request until a last part or segment of the SDU (e.g., the full SDU) is transmitted (e.g., mapped to an RLC AMD PDU or submitted to lower layers for transmission). The WTRU may determine whether at least a part of the SDU is pending for transmission based on a HARQ process associated with the part of the SDU. The WTRU may delay triggering a SDU retransmission or a poll request transmission until all pending retransmissions for the SDU at the HARQ layer are completed (e.g., are no longer pending) or have exceeded the maximum number of HARQ retransmissions allowed.

In examples, the WTRU may determine, as a second condition associated with an autonomous SDU retransmission or a polling request transmission, whether a transmission delay time period has expired. For example, the WTRU may start a first timer associated with an SDU upon submitting the last part of the SDU to lower layers for transmission. The start of the timer may be performed regardless of whether a remaining time of the SDU exceeds t-ThresholdAutoRe Tx. The submission of the last part of the SDU to the lower layers may be done for an initial transmission or a re-transmission of the SDU. If the WTRU determines that a first condition associated with an autonomous SDU retransmission is met (e.g., the remaining time of the SDU is below t-ThresholdAutoReTx or a threshold number of HARQ re-transmissions for a HARQ process associated with the SDU have been reached), the WTRU may further check, as a second condition for the retransmission, whether the first timer is running. If the first timer is not running (e.g., the timer was never started or has expired), which may indicate that there is no delay required, the WTRU may trigger an autonomous re-transmission of the SDU (or a SDU segment). The WTRU may restart the first timer upon triggering and/or performing the SDU retransmission.

The WTRU may perform an autonomous SDU retransmission after having transmitted a polling request for the associated SDU and for a segment of the associated SDU. The polling request may be transmitted based on one or more of the conditions described herein, for example, upon determining that a remaining time associated with the SDU has fallen below a threshold (e.g., t-ThresholdPoll), if configured.

In examples, the WTRU may start a second timer upon triggering a polling request transmission (e.g., including the poll in an AMD PDU) and may determine whether a second condition associated with a SDU retransmission is met based on the timer (e.g., use the second timer as a prohibit timer to trigger the autonomous re-transmission). The second timer may be used to determine whether to autonomously re-transmit all fully transmitted SDUs up to the AMD PDU that includes the poll. The second timer may be used to determine whether to autonomously re-transmit all fully transmitted RLC SDUs for which a remaining time is not below a threshold (e.g., t-ThresholdAutoReTx) before the AMD PDU comprising the poll is transmitted (e.g., the WTRU may trigger autonomous re-transmissions of the SDUs that have satisfied retransmission conditions including having a remaining time below t-ThresholdAutoReTx).

If the WTRU determines that a first condition associated with an autonomous SDU retransmission is met (e.g., the remaining time of the SDU is below t-ThresholdAutoReTx or a threshold number of HARQ re-transmissions for a HARQ process associated with the SDU have been reached), the WTRU may further check, as a second condition for the retransmission, whether the second timer is running. If the second timer is not running (e.g., the timer was never started or has expired), which may indicate that there is no delay required, the WTRU may trigger an autonomous re-transmission of a SDU (or a SDU segment).

Example operations associated with autonomous retransmissions of data (e.g., one or more SDUs or one or more segments of a SDU) or transmissions of polling requests may include one or more of the following. A WTRU may be configured with a first set of conditions for triggering an autonomous SDU retransmission or a polling request transmission (e.g., to request a status report from a peer entity such as an Rx RLC entity). The first set of conditions may be based on a time period (e.g., which may be monitored using a timer) such as a remaining time associated with an SDU, which, if falling below a threshold value, may trigger an autonomous retransmission of a SDU or a transmission of a polling request. The first set of conditions may be based on a retransmission threshold such as a threshold number of HARQ retransmissions allowed before a SDU retransmission or a poll transmission is triggered. The first set conditions may be based on other factors such as whether a last SDU or PDU of a PDU set has been transmitted.

The WTRU may be configured with a second set of conditions (e.g., additional conditions) for triggering an autonomous retransmission of a SDU or a polling request transmission (e.g., to request a status report from a peer entity). The second set of conditions may be based on whether one or more parts of the SDU are pending for transmission or re-transmission (e.g., in a transmission buffer of the WTRU). In response to determining that at least a part of the SDU is pending for transmission or re-transmission in the transmission buffer. The second set of conditions may be based on a transmission time delay from a previous transmission or retransmission associated with the SDU or from a previous polling request transmission. Such a time delay may be tracked/monitored using a timer. For example, the WTRU may monitor a transmission time delay associated with a previous transmission or retransmission of a SDU by starting a first timer for the SDU upon submitting a last part of the SDU for transmission (e.g., by lower layers). The WTRU may monitor a transmission time delay associated with a previous polling request by starting a second timer upon triggering a polling request transmission (e.g., by including a poll in a PDU).

The WTRU may determine that one or more of the first set of conditions have been met and the WTRU may further determine whether one or more of the second set of conditions have been met. For example, the WTRU may determine, as a second condition, whether one or more parts of a SDU is pending for transmission or re-transmission in a transmission buffer of the WTRU. In response to determining that at least one part of the SDU is pending for transmission or re-transmission in the transmission buffer, the WTRU may delay triggering a retransmission of the SDU (e.g., the whole SDU or a segment of the SDU) and/or delay triggering a polling request transmission until the last part of the SDU is submitted for transmission (e.g., is mapped to a PDU or submitted to lower layers for transmission). As another example, the WTRU may trigger a retransmission of the SDU (e.g., the whole SDU or a segment of the SDU) and/or a polling request transmission if the first timer described herein is not running (e.g., which may indicate that a transmission delay from a previous SDU transmission or retransmission has been fulfilled). As yet another example, the WTRU may trigger a retransmission of the SDU (e.g., the whole SDU or a segment of the SDU) and/or a polling request transmission if the second timer described herein is not running (e.g., which may indicate that a transmission delay from a previous poll transmission has been fulfilled). Conversely, the WTRU may delay triggering a retransmission of the SDU (e.g., the whole SDU or a segment of the SDU) and/or a polling request transmission if the first timer or the second timer described herein is still running (e.g., which may indicate that the WTRU is still within the duration of the transmission time delay).

If the WTRU determines that the first condition and the second condition are both met or fulfilled, the WTRU may perform one or more of the following. The WTRU may consider, initiate, or trigger the retransmission of the SDU (e.g., one or more segments of the SDU). The WTRU may trigger the transmission of a polling request (e.g., by including the polling request in an RLC PDU).

A WTRU may be configured with one or more conditions for determining a radio link problem (e.g., such as an RLF) that may be associated with autonomous SDU retransmissions. As described herein, the WTRU may trigger an autonomous retransmission of a SDU (e.g., the whole SDU or a segment of the SDU) based on one or more configured triggering conditions. The WTRU may determine whether to increase a retransmission counter for the SDU (e.g., based on the condition that triggers the SDU retransmission) and may increase or cease incrementing the retransmission counter based on the determining. For example, the WTRU may make a first determination that the autonomous SDU retransmission is triggered based on one or more of the triggering conditions described herein. The SDU may have been considered for re-transmission before this event (e.g., before the autonomous SDU retransmission is triggered) based on peer entity status reports or based on one or more earlier autonomous re-transmission triggers. The WTRU may further determine, based on at least one additional condition and the first determination, whether to increment a retransmission counter for the SDU. The additional condition may be based on the time elapsed since the initial or a previous (re-)transmission of the SDU being equal to or above a threshold level. The additional condition may be based on the SDU being pending for retransmission due to one or more conditions for autonomous re-transmission being met and/or a status report indicating an NACK for the SDU being received. The additional condition may be based on a configuration from the network about whether to increase the re-transmission counter based on an autonomous retransmission. The additional condition may be based on an indication (e.g., included in a status report) of whether to increase the retransmission counter (e.g., the status report may indicate an NACK for the SDU). The WTRU may increase or cease increasing the retransmission counter based on the second determination. Using these techniques, autonomous retransmissions of SDUs may not lead to an RLF unless it is actually reasonable to trigger the RLF, resulting in better user experience.

In examples, if an autonomous re-transmission is triggered for an SDU (e.g., an RLC SDU) based on one or more conditions (e.g., the conditions described herein) and the SDU is considered for retransmission, a retransmission counter such as RETX_COUNT associated with the SDU may not incremented unless the time elapsed since the initial or a previous (re-)transmission of the SDU is equal to or above a threshold value. In examples, a WTRU may start a timer (e.g., a third timer, which may or may not be equal to the first timer described herein) associated with the SDU upon submitting the last part of the SDU for transmission or retransmission. If the third timer is not running when an autonomous SDU retransmission is triggered, the counter (e.g., RETX_COUNT) associated with the SDU may be incremented. This may ensure that an autonomous re-transmission triggered soon after a previous transmission of an SDU does not lead to an RLF before a STATUS PDU could be received from a peer entity (e.g., a peer RLC entity of a network device such as a base station).

In examples, when an SDU (e.g., a segment of the SDU) is pending for retransmission due to an autonomous retransmission trigger and a STATUS PDU with an NACK for the SDU (e.g., the segment of the SDU) is received, a WTRU (e.g., an RLC entity of the WTRU) may increase a retransmission counter (e.g., RETX_COUNT) associated with the SDU. The Status PDU may include an “increment by one” instruction, a “decrement by one” instruction, an instruction to increment or decrement the counter by a configured delta value, or an instruction to increment or change the counter to a specific number. These operations may be performed in the case where the counter (e.g., RETX_COUNT) is not increased based on an autonomous retransmission trigger but the STATUS PDU is received when the SDU is pending for retransmission. As a result, the triggering of an RLF may or may not be prevented. The provision of an indication to decrease the counter via an instruction in the status PDU may be performed based on an assumption that the WTRU may increase the counter based on an autonomous retransmission.

A network device such as a base station may provide configuration information to a WTRU regarding whether or not a retransmission counter (e.g., RETX_COUNT) may be incremented based on an autonomous retransmission trigger. Such configuration information may be provided per WTRU, per RLC entity, or per autonomous retransmission trigger condition. For example, the configuration information from the network may indicate that the retransmission counter (e.g., RETX_COUNT) may be incremented based on an autonomous retransmission triggered by a remaining time threshold, but not based on an autonomous retransmission triggered by a HARQ retransmission count.

In examples, when a network device such as a base station sends a STATUS PDU for a WTRU, the STATUS PDU may indicate not to increment the transmission counter (e.g., RETX_COUNT) for at least part of an SDU indicated by an NACK in the STATUS PDU. This technique may be useful because the network device may track the number of NACKs it has sent for a particular RLC SN (e.g., which may be associated with a particular RLC SDU) and the network device may intend not to trigger an RLF based on an autonomous retransmission trigger at the WTRU. In examples, the indication may be provided per SDU in the STATUS PDU or for the whole STATUS PDU. The indication to not increment the transmission counter may include or be associated with a configuration (e.g., a configured time period or number of retransmissions during which the WTRU may not increase the transmission counter).

In examples, different maxRetxThreshold values may be applied by a WTRU to an SDU depending on whether the SDU is delay critical or not. For example, the maxRetxThreshold value applied to a SDU that is becoming delay critical may be higher than the maxRetxThreshold applied before the SDU becomes delay critical. In examples, the WTRU may increment a retransmission counter once per x configured number of retransmissions, wherein the retransmissions may be triggered as autonomous retransmissions. An SDU may become delay-critical if a remaining time associated with SDU (e.g., based on the remaining time of a discardTimer) falls below a threshold value.

Example operations associated with RLF handling due to autonomous SDU re-transmissions may include one or more of the following. A WTRU may be configured to perform autonomous SDU re-transmissions based on one or more triggering conditions in one or more configured entities (e.g., one or more RLC entities). The triggering conditions for the autonomous re-transmissions may include those described herein. The WTRU may determine (e.g., as a first determination) that an autonomous retransmission is triggered for a SDU based on the triggering conditions and the SDU is considered for retransmission (e.g., the SDU may have been considered for retransmission before this event based on peer entity status reports or based on an earlier autonomous retransmission trigger). The WTRU may further determine (e.g., as a second determination), based on one or more additional conditions and the first determining, whether to increment a retransmission counter associated with the SDU. The one or more additional conditions may be based on the time elapsed since the initial or a previous transmission or retransmission of the SDU being equal to or above a threshold value. The one or more additional conditions may be based on the SDU being pending for retransmission due to one or more triggering conditions for autonomous retransmission and/or based on reception of a status report indicating an NACK for the SDU. The one or more additional conditions may be based on a configuration from the network regarding whether to increment the retransmission counter based on an autonomous retransmission trigger. The one or more additional conditions may be based on an indication included in a status report regarding whether to increment the retransmission counter when the status report indicates an NACK for the SDU. The WTRU may increment or cease incrementing the retransmission counter based on the second determining.

Although features and elements described above are described in particular combinations, each feature or element may be used alone without the other features and elements of the preferred embodiments, or in various combinations with or without other features and elements. Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU), comprising:
a processor configured to:
receive, from a network device, configuration information associated with a service data unit (SDU), wherein the configuration information indicates a first condition associated with SDU retransmission, wherein the first condition is based on a remaining time associated with the SDU;
determine whether the first condition and a second condition are both met, wherein the second condition is based on whether at least a part of the SDU is submitted to lower layers for transmission; and
re-transmit at least a segment of the SDU to the network device based on a determination that the first condition and the second condition are both met.

2. The WTRU of claim 1, wherein the processor is configured to re-transmit at least the segment of the SDU to the network device autonomously without receiving a negative acknowledgment associated with the SDU from the network device.

3. The WTRU of claim 1, wherein the processor is configured to determine that the second condition is not met if the part of the SDU is pending for transmission or retransmission.

4. The WTRU of claim 1, wherein the second condition is further based on whether a transmission delay time period associated with a previous transmission or retransmission of the SDU has expired.

5. The WTRU of claim 4, wherein the processor is configured to start monitoring the transmission delay time period upon initiating the previous transmission or retransmission of the SDU.

6. The WTRU of claim 4, wherein the processor is configured to determine that the second condition is not met if the transmission delay time period has not expired.

7. The WTRU of claim 1, wherein the second condition is further based on to whether a transmission delay time period associated with a transmission of a polling request to the network device has expired.

8. The WTRU of claim 7, wherein the processor is configured to start monitoring the transmission delay time period upon initiating the transmission of the polling request to the network device.

9. The WTRU of claim 7, wherein the processor is configured to determine that the second condition is not met in response to determining that the transmission delay time period has not expired.

10. The WTRU of claim 1, wherein the processor is configured to postpone re-transmitting at least the segment of the SDU in response to determining that the first condition is met but the second condition is not met.

11. The WTRU of claim 1, wherein the configuration information further indicates a third condition and a fourth condition associated with a transmission of a polling request to the network device for status reporting, wherein the third condition is based on an amount of data transmitted without polling or a buffer status of the WTRU, wherein the fourth condition is based on whether the part of the SDU is pending for transmission or retransmission, or whether a transmission delay time period associated with the SDU or with a previously transmitted polling request has expired, and wherein the processor is further configured to:
determine whether the third condition and the fourth condition are both met; and
transmit the polling request based on a determination that the third condition and the fourth condition are both met.

12. A method implemented by a wireless transmit/receive unit (WTRU), the method comprising:
receiving, from a network device, configuration information associated with a service data unit (SDU), wherein the configuration information indicates a first condition associated with SDU retransmission, wherein the first condition is based on a remaining time associated with the SDU;
determining whether the first condition and a second condition are both met, wherein the second condition is based on whether at least a part of the SDU is submitted to lower layers for transmission; and
re-transmitting at least a segment of the SDU to the network device based on a determination that the first condition and the second condition are both met.

13. The method of claim 12, wherein re-transmitting at least the segment of the SDU to the network device is performed autonomously without receiving a negative acknowledgment associated with the SDU from the network device.

14. The method of claim 12, wherein the method further comprises determining that the second condition is not met if the part of the SDU is pending for transmission or retransmission.

15. The method of claim 12, wherein the second condition is further based on whether a transmission delay time period associated with a previous transmission or retransmission of the SDU has expired.

16. The method of claim 15, wherein, within the transmission delay time period, the second condition is determined not to be met.

17. The method of claim 12, wherein the second condition is further based on whether a transmission delay time period associated with a transmission of a polling request to the network device has expired.

18. The method of claim 17, wherein, within the transmission delay time period, the second condition is determined not to be met.

19. The method of claim 12, wherein re-transmitting at least the segment of the SDU is postponed in response to determining that the first condition is met but the second condition is not met.

20. The method of claim 12, wherein the configuration information further indicates a third condition and a fourth condition associated with a transmission of a polling request to the network device for status reporting, wherein the third condition is based on an amount of data transmitted without polling or a buffer status of the WTRU, wherein the fourth condition is based on whether the part of the SDU is pending for transmission or retransmission, or whether a transmission delay time period associated with the SDU or with a previously transmitted polling request has expired, and wherein the method further comprises:
determining whether the third condition and the fourth condition are both met; and
transmitting the polling request based on a determination that the third condition and the fourth condition are both met.
